(19) United States
(12) Patent Application Publication
(10) Pub. No.: US 2026/0067720 A1
(43) Pub. Date: Mar. 5, 2026

(54) FAILURE PREDICTION APPARATUS, RADIO COMMUNICATION SYSTEM, AND FAILURE PREDICTION PROGRAM

(71) Applicant: Fujitsu Limited, Kawasaki-shi (JP)

(72) Inventors: Nanase OKUMURA, Ota (JP); Kousuke Iemura, Kawasaki (JP); Yasunari Izawa, Sagamihara (JP)

(73) Assignee: Fujitsu Limited, Kawasaki-shi (JP)

(21) Appl. No.: 19/308,965

(22) Filed: Aug. 25, 2025

(30) Foreign Application Priority Data
Sep. 2, 2024 (JP) 2024-150447

(51) Int. Cl. H04W 24/04

(52) U.S. Cl. CPC H04W 24/04

(57) ABSTRACT

A non-transitory computer-readable storage medium storing therein a failure prediction program for causing a computer to execute a process includes, generating at least one of first correlation coefficient data representing a similarity between first communication state data representing a communication state of a first cell provided by a first base station and second communication state data representing a communication state of a second cell provided by a second base station, or second correlation coefficient data representing a similarity between the first communication state data and third communication state data representing a communication state in a communication area of the first base station, and determining a state of the first base station or the first cell on the basis of at least one of the first correlation coefficient data or the second correlation coefficient data.

### CROSS-REFERENCE TO RELATED APPLICATION

This application is based upon and claims the benefit of priority of the prior Japanese Patent Application No. 2024-150447, filed on Sep. 2, 2024, the entire contents of which are incorporated herein by reference.

### FIELD

The present invention relates to an apparatus, a method, and a program for predicting a failure that will occur in a radio communication system.

### BACKGROUND

A fifth-generation mobile communication system (5G) is widely used, and traffic is rapidly increasing. However, in a radio communication system with a large amount of traffic, when a failure occurs in a network device such as a base station device, the damage is likely to be high. Thus, there is a demand for a technique for predicting a failure by monitoring an operation state of a radio communication system. For example, there is a demand for a method of detecting a silent failure such as a situation where some traffic processing is not performed even if a radio communication system appears to be operating normally. A silent failure indicates a situation in which the failure does not immediately affect the service quality, but the perceived quality of an end user deteriorates if left unattended.

JP 2017-050715 A discloses a method of monitoring a virtual network function. JP 2016-144153 A discloses a method of monitoring a service by using flow data collected from a plurality of network devices. JP 2011-091678 A discloses a method of accurately detecting a failure in a network device.

### SUMMARY

As described above, the technique of predicting a failure in a radio communication system is considered to be important. However, in the conventional technique, prediction accuracy is not necessarily sufficient. Therefore, there is the need for improving the accuracy of predicting a failure in a radio communication system.

A non-transitory computer-readable storage medium storing therein a failure prediction program for causing a computer to execute a process includes, generating at least one of first correlation coefficient data representing a similarity between first communication state data representing a communication state of a first cell provided by a first base station and second communication state data representing a communication state of a second cell provided by a second base station, or second correlation coefficient data representing a similarity between the first communication state data and third communication state data representing a communication state in a communication area of the first base station, and determining a state of the first base station or the first cell on the basis of at least one of the first correlation coefficient data or the second correlation coefficient data. coefficient data or the second correlation coefficient data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a radio communication system according to an embodiment of the present invention.

FIG. 2 is a diagram illustrating an example of a failure prediction apparatus according to an embodiment of the present invention.

FIGS. 3A and 3B are diagrams illustrating a configuration example of a base station that provides a cell.

FIG. 4 is a diagram illustrating another configuration example of a base station that provides a cell.

FIG. 5 is a diagram illustrating an example of a method of selecting a reference cell for a target cell.

FIG. 6 is a diagram illustrating an example of communication state data of a target cell and a reference cell.

FIG. 7 is a diagram illustrating an example of a monitor period for monitoring a similarity between a communication state of a target cell and a communication state of a reference cell.

FIGS. 8A and 8B are diagrams illustrating an example of a method of calculating a correlation coefficient between a communication state of a target cell and a communication state of a reference cell.

FIG. 9 is a diagram illustrating an example of a correlation coefficient calculated for each monitor period.

FIG. 10 is a diagram for describing traffic in a communication area of a base station.

FIG. 11 is a diagram illustrating an example of a traffic volume calculated for a target base station.

FIG. 12 is a diagram illustrating an example of an operation of an autocorrelation calculation unit.

FIGS. 13A and 13B are diagrams (part 1) illustrating an example of a process of generating feature amount data from correlation coefficient data.

FIG. 14 is a diagram (part 2) illustrating an example of a process of generating feature amount data from correlation coefficient data.

FIG. 15 is a diagram (part 3) illustrating an example of a process of generating feature amount data from correlation coefficient data.

FIG. 16 is a diagram illustrating an example of learning of an AI model.

FIG. 17 is a diagram illustrating an example of a method of predicting a failure in a base station by using a trained AI model.

FIG. 18 is a diagram illustrating an example of another method of predicting a failure in a base station.

FIG. 19 is a flowchart illustrating an example of a process of the failure prediction apparatus.

FIG. 20 is a diagram illustrating an example of a hardware configuration of the failure prediction apparatus.

### DESCRIPTION OF EMBODIMENTS

In a standardization organization such as 3rd Generation Partnership Project (3GPP) (registered trademark) or Open RAN (O-RAN) Alliances, radio access network (RAN) standardization is in progress. An O-RAN architecture in which a RAN Intelligent Controller (RIC) is introduced based on the 3GPP specification is provided by the O-RAN.

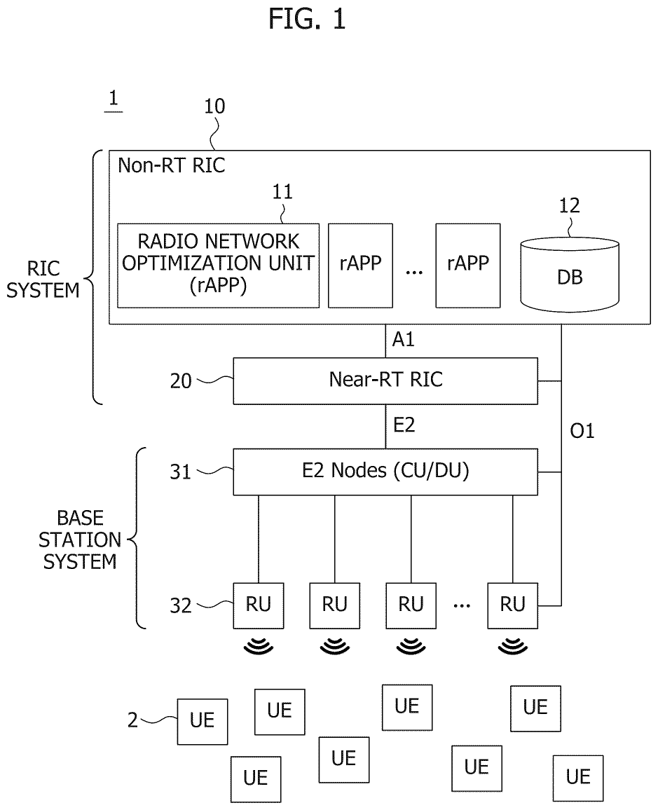

FIG. 1 illustrates an example of a radio communication system according to an embodiment of the present invention. A radio communication system 1 according to the embodiment of the present invention is configured on the basis of, for example, an O-RAN architecture. In this case, the radio communication system 1 includes an RIC system and a base station system.

The RIC system provides services to each device or each function in the O-RAN architecture. The RIC system includes a non-real-time RIC 10 and a near-real-time RIC 20.

The non-real-time RIC 10 is implemented in a service management orchestration (SMO) although not specifically illustrated. The near-real-time RIC 20 is provided outside of the SMO in many cases. The non-real-time RIC 10 and the near-real-time RIC 20 are connected via an A1 interface. The A1 interface includes A1-P and A1-EI.

The base station system includes one or more E2 nodes 31 and a plurality of radio units (RUs) 32. The E2 node 31 includes a central node (CU) and a distributed node (DU).

The E2 node 31 provides radio link control, media access control, PHY-High functions, and the like, and processes signals of the RUs 32 at higher layers. Note that a plurality of RUs 32 may be connected to each DU. Also, the E2 node 31 may obtain radio access network configuration information and statistical information and provide the information to the non-real-time RIC 10.

The RU 32 may include a radio circuit and accommodate a plurality of pieces of user equipment (UE). The RU 32 is connected to the non-real-time RIC 10 via an O1 interface or an Open fronthaul interface (not illustrated). The RU 32 performs radio communication according to an instruction given from the E2 node 31. Each RU 32 can provide one or more radio cells.

The non-real-time RIC 10 can periodically obtain various types of data from the E2 node 31 via the O1 interface. Specifically, the non-real-time RIC 10 collects performance management (PM) data and configuration management (CM) data. The non-real-time RIC 10 also collects position data representing a position of each UE. The non-real-time RIC 10 may acquire fault management data (FM data) and trace management data (TM data).

Various application programs may be implemented in the non-real-time RIC 10. For example, the non-real-time RIC 10 includes a radio network optimization unit 11 that determines optimal parameters according to a radio environment and traffic demand by using an AI/ML model and provides the determined optimal parameters to the E2 node 31 via the O1 interface. The non-real-time RIC 10 generates a policy related to control of the radio access network and notifies the near-real-time RIC 20 of the policy via the A1 interface. In the following description, an application program that operates in the non-real-time RIC 10 may be referred to as “rApp”. The radio network optimization unit 11 is realized as rApp.

The non-real-time RIC 10 includes a database (DB) 12. The database 12 stores PM data and CM data acquired by the non-real-time RIC 10 from the E2 node 31.

The near-real-time RIC 20 collects and analyzes radio access network configuration and statistical information from the E2 node 31 via the E2 interface. The near-real-time RIC 20 controls the E2 node 31 according to the policy reported from the non-real-time RIC 10. In the following description, an application program that operates in the near-real-time RIC 20 may be referred to as “xApp”.

Note that the A1 interface connects the non-real-time RIC 10 to the near-real-time RIC 20. The E2 interface connects the near-real-time RIC 20 to the E2 node 31.

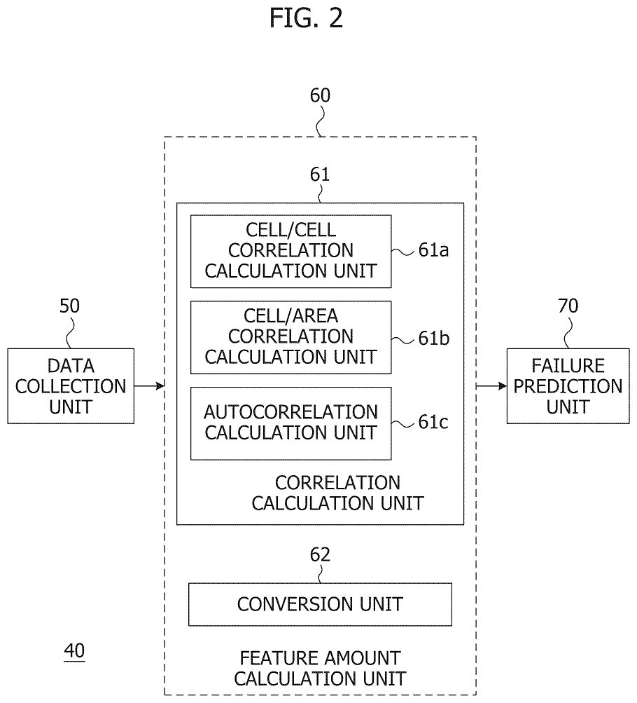

FIG. 2 illustrates an example of a failure prediction apparatus according to an embodiment of the present invention. A failure prediction apparatus 40 according to the embodiment of the present invention includes a data collection unit 50, a feature amount calculation unit 60, and a failure prediction unit 70. The failure prediction apparatus 40 may further include other functions not illustrated in FIG. 2. The failure prediction apparatus 40 is implemented by, for example, rApp mounted on the non-real-time RIC 10 illustrated in FIG. 1. In this case, the function of the failure prediction apparatus 40 may be a part of the radio network optimization unit 11.

The data collection unit 50 periodically collects communication state data indicating a communication state of each cell provided by each base station. The communication state data is not particularly limited, and is collected at intervals of 5 minutes to 15 minutes, for example. The communication state data collected by the data collection unit 50 is stored in the database 12 in the configuration illustrated in FIG. 1.

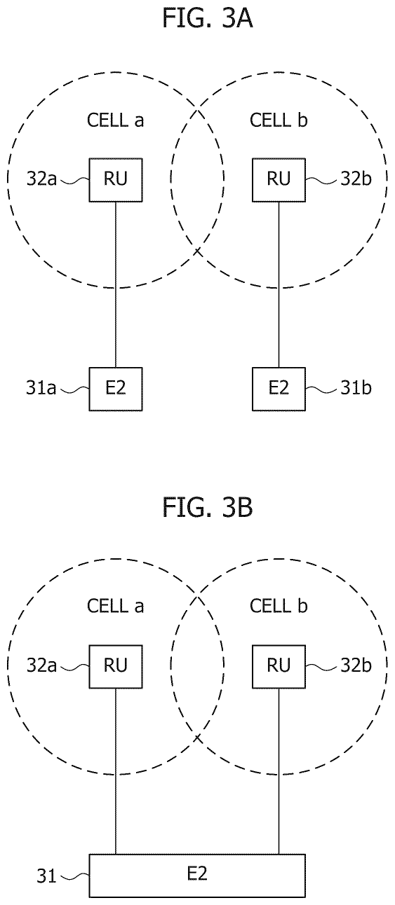

The cell is provided by a base station. Here, the base station includes an E2 node (CU/DU) 31 and an RU 32. For example, in the case illustrated in FIG. 3A, a cell a is provided by a base station including an E2 node 31a and an RU 32a. A cell b is provided by a base station including an E2 node 31b and an RU 32b. However, the E2 node 31 may accommodate a plurality of RUs 32 as illustrated in FIG. 3B. In this case, the cell a is provided by a base station including the E2 node 31 and the RU 32a, and the cell b is provided by a base station including the E2 node 31 and the RU 32b.

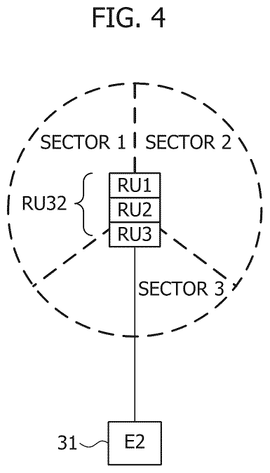

Although one RU 32 forms one cell in the example illustrated in FIGS. 3A and 3B, one RU 32 may form a plurality of cells. For example, in the case illustrated in FIG. 4, a base station including the E2 node 31 and the RU 32 provides three sectors (sectors 1 to 3). Here, it is assumed that the RU 32 includes three RU modules (RU1 to RU3) and processes communication for each sector. In this case, each “sector” corresponds to a “cell”. The sector 1 is provided by a base station including the E2 node 31 and the RU module 1, the sector 2 is provided by a base station including the E2 node 31 and the RU module 2, and the sector 3 is provided by a base station including the E2 node 31 and the RU module 3.

The communication state data collected by the data collection unit 50 includes the PM data described above. The PM data represents a traffic volume, the number of active users, and the like of each cell. The traffic volume of the cell is represented by, for example, a utilization rate of a resource block. The number of active users represents the number of pieces of UE 2 in communication.

The communication state data may include the CM data described above. The CM data includes information indicating a frequency band used in a cell, information indicating a position where each RU 32 is installed (for example, latitude and longitude), information indicating an antenna height of each RU 32, and the like. However, since the CM data does not change dynamically, the need for periodically collecting the CM data is eliminated.

The communication state data may include position data representing a position of the UE 2. The position data may be global positioning system (GPS) data. The data collection unit 50 does not need to collect position data of all the pieces of UE 2. For example, the data collection unit 50 collects position data of the UE 2 permitted to provide the position data.

The feature amount calculation unit 60 calculates a feature amount related to a communication state of each base station or each cell on the basis of the communication state data collected by the data collection unit 50. The feature amount calculation unit 60 includes a correlation calculation unit 61 and a conversion unit 62.

The correlation calculation unit 61 includes a cell/cell correlation calculation unit 61a, a cell/area correlation calculation unit 61b, and an autocorrelation calculation unit 61c. The cell/cell correlation calculation unit 61a calculates a correlation between a communication state of a target cell and a communication state of a reference cell. The “target cell” is a cell in which the presence or absence of a failure is to be predicted. The “reference cell” is one of cells located around the target cell, and is selected according to a method that will be described later. The cell/area correlation calculation unit 61b calculates a correlation between a communication state of a target base station that provides a target cell and a communication state within a communication area of the target base station. The autocorrelation calculation unit 61c calculates an autocorrelation between communication states of a target cell in different time periods.

In this specification, “correlation” may be read as “similarity”. The correlation calculation unit 61 does not need to include all of the cell/cell correlation calculation unit 61a, the cell/area correlation calculation unit 61b, and the autocorrelation calculation unit 61c. That is, the correlation calculation unit 61 may include one or more of a cell/cell correlation calculation unit 61a, a cell/area correlation calculation unit 61b, and an autocorrelation calculation unit 61c. However, the correlation calculation unit 61 preferably includes at least one of a cell/cell correlation calculation unit 61a or a cell/area correlation calculation unit 61b.

The conversion unit 62 converts a correlation coefficient calculated by the correlation calculation unit 61 into a predetermined feature amount. The feature amount represents, for example, the magnitude of change in a correlation coefficient calculated by the correlation calculation unit 61. Alternatively, the feature amount may represent a slope of change in a correlation coefficient calculated by the correlation calculation unit 61. That is, the feature amount obtained by the conversion unit 62 represents a feature of the communication state of the target base station or the target cell.

The failure prediction unit 70 determines the communication state of the target base station or the target cell based on the feature amount calculated by the feature amount calculation unit 60. For example, the failure prediction unit 70 predicts whether a failure will occur in the target base station. In this case, the failure prediction unit 70 may predict whether the base station will fail by using an AI model created in advance.

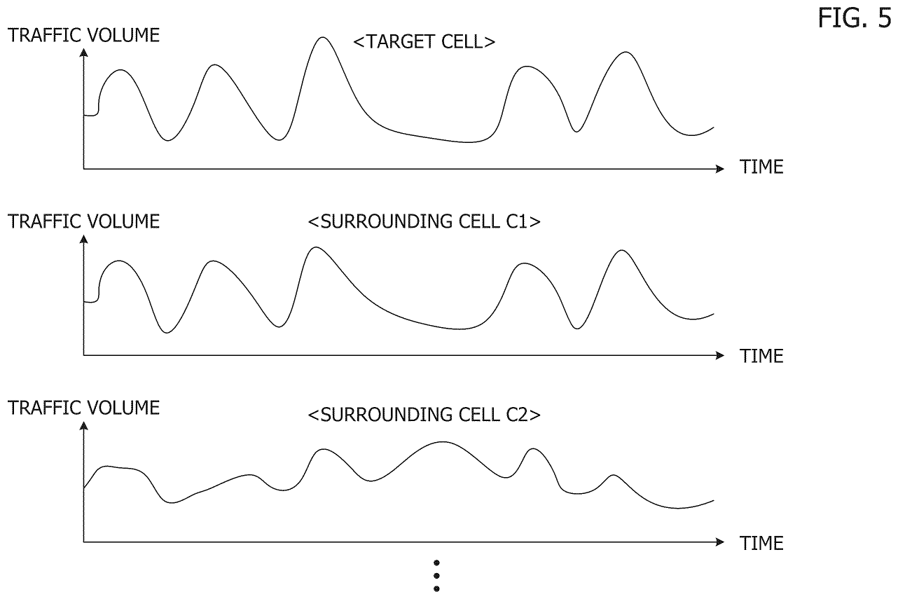

FIG. 5 illustrates an example of a method in which the cell/cell correlation calculation unit 61a selects a reference cell for a target cell. In the present embodiment, it is assumed that a reference cell is selected on the basis of traffic of each cell.

First, the cell/cell correlation calculation unit 61a extracts a plurality of surrounding cells located in the vicinity of a target cell. A position of each cell is represented by, for example, latitude and longitude of a position where the RU 32 forming the cell is provided. In a case where a cell is formed in a specific direction with respect to the RU 32, a position of the cell is determined on the basis of the position of the RU 32 and the direction in which the cell is formed. In FIG. 5, surrounding cells C1, C2, . . . are extracted for the target cell.

The cell/cell correlation calculation unit 61a acquires traffic data indicating traffic volumes of the target cell and each of the surrounding cells C1, C2, . . . . In this case, the cell/cell correlation calculation unit 61a may acquire traffic data of each cell according to a cycle in which a traffic volume varies. For example, traffic data for one week of each cell is acquired. The cell/cell correlation calculation unit 61a calculates a correlation coefficient between the traffic data of the target cell and the traffic data of each of the surrounding cells C1, C2, . . . . As a result, a surrounding cell having the highest similarity to the target cell is selected as a “reference cell”. In the example illustrated in FIG. 5, the surrounding cell C1 is selected as a reference cell.

In the example illustrated in FIG. 5, the reference cell is selected on the basis of a traffic volume, but the reference cell may be selected by using another communication state. For example, the cell/cell correlation calculation unit 61a may select the reference cell on the basis of a similarity of the number of pieces of UE 2 located in the cell.

As described above, the reference cell is selected from among the surrounding cells located in the vicinity of the target cell. Here, the communication state of the reference cell is similar to the communication state of the target cell. In the embodiment of the present invention, it is assumed that when the base station providing the target cell is normal, a state in which the correlation coefficient between the communication state of the target cell and the communication state of the reference cell is high is maintained. Therefore, the cell/cell correlation calculation unit 61a continuously monitors a correlation coefficient representing the similarity between the communication state of the target cell and the communication state of the reference cell.

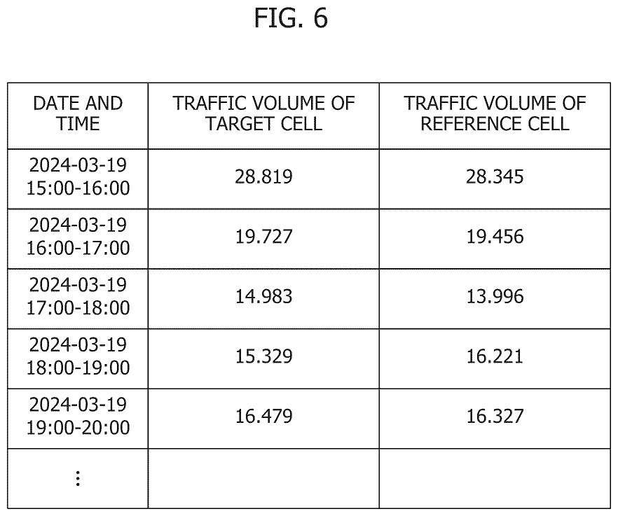

FIG. 6 illustrates an example of communication state data of a target cell and a reference cell. In the present embodiment, a traffic volume is used as the communication state data. In the present embodiment, the traffic volume is calculated in units of one hour. This calculation result is stored in, for example, the database 12 illustrated in FIG. 1.

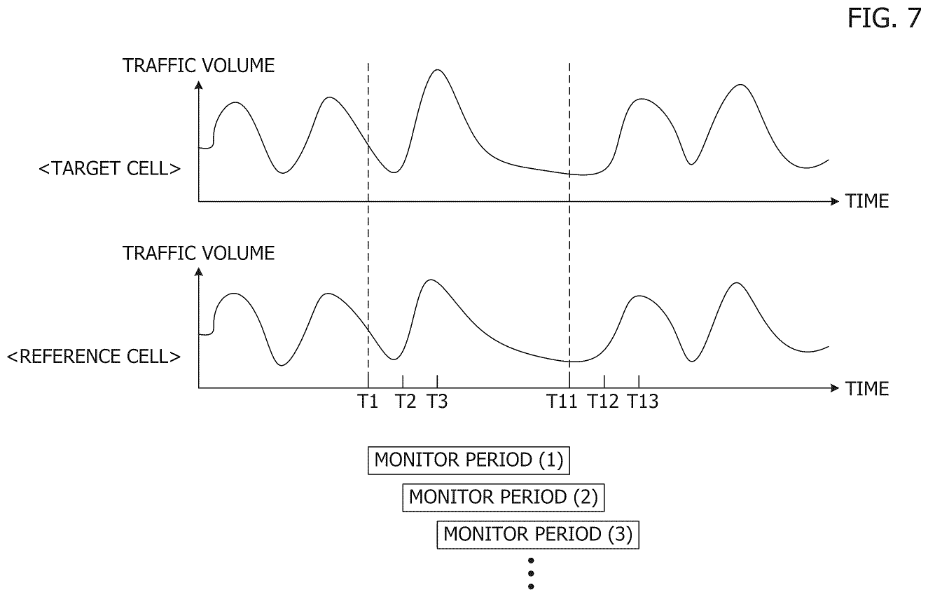

FIG. 7 illustrates an example of a monitor period for monitoring a similarity between a communication state of a target cell and a communication state of a reference cell. The length of the monitor period is not particularly limited, but is, for example, 24 hours. A plurality of monitor periods are set while being shifted by a predetermined time.

In the example illustrated in FIG. 7, a monitor period (1) is set from time point T1 to time point T11. The difference between time point T1 and time point T11 is 24 hours. A monitor period (2) is set from time point T2 to time point T12. Here, the time period in which the monitor period (2) is set is shifted by one hour with respect to the monitor period (1), for example. Hereinafter, a subsequent monitor period is similarly set.

The cell/cell correlation calculation unit 61a calculates a correlation coefficient representing the similarity between the communication state of the target cell and the communication state of the reference cell in each monitor period. Specifically, in each monitor period, the cell/cell correlation calculation unit 61a calculates a correlation coefficient representing a similarity between a variation pattern of the communication state of the target cell and a variation pattern of the communication state of the reference cell. In the present embodiment, the length of the monitor period is 24 hours. As illustrated in FIG. 6, traffic volumes of the target cell and the reference cell are calculated in units of one hour. Therefore, each monitor period includes 24 sampling points. As a result, a variation pattern of the traffic volume is obtained for each monitor period.

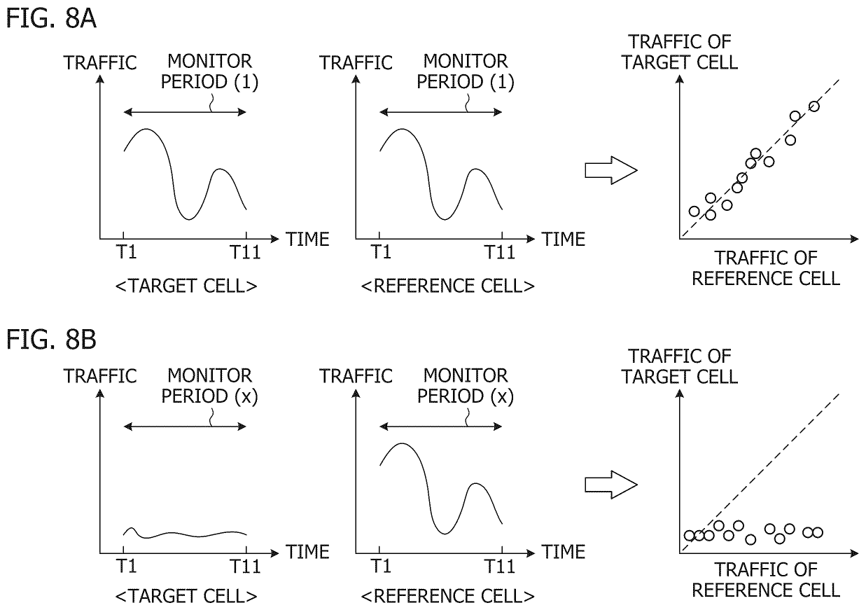

FIGS. 8A and 8B illustrate an example of a method of calculating a correlation coefficient between a communication state of a target cell and a communication state of a reference cell. FIG. 8A illustrates a case where the target cell is normal, and FIG. 8B illustrates a case where an abnormality occurs in the target cell.

In the case illustrated in FIG. 8A, a correlation between the communication state of the target cell and the communication state of the reference cell is calculated in the monitor period (1). The cell/cell correlation calculation unit 61a plots a sampling pair value representing a pair of the traffic volume of the target cell and the traffic volume of the reference cell obtained at each of the 24 sampling points in the monitor period (1) on an XY plane. In this case, the traffic volume of the target cell may be normalized with respect to the traffic volume of the reference cell. In this example, the X-axis represents the traffic volume of the reference cell, and the Y-axis represents the traffic volume of the target cell. A mark “∘” illustrated in FIGS. 8A and 8B represents a pair of the traffic volume of the target cell and the traffic volume of the reference cell obtained at one sampling point.

In a case where the target cell is normal, it is considered that a state in which the correlation coefficient between the communication state of the target cell and the communication state of the reference cell is high is maintained. For example, when the traffic of the reference cell increases, the traffic of the target cell also increases. In this case, as illustrated in FIG. 8A, a high correlation coefficient is obtained between the traffic volume of the target cell and the traffic volume of the reference cell. That is, the correlation coefficient approaches 1.

In the case illustrated in FIG. 8B, even if the traffic volume of the reference cell increases, the traffic volume of the target cell does not increase so much. In this case, a high correlation coefficient is less likely to be obtained between the traffic volume of the target cell and the traffic volume of the reference cell. That is, the correlation coefficient approaches zero.

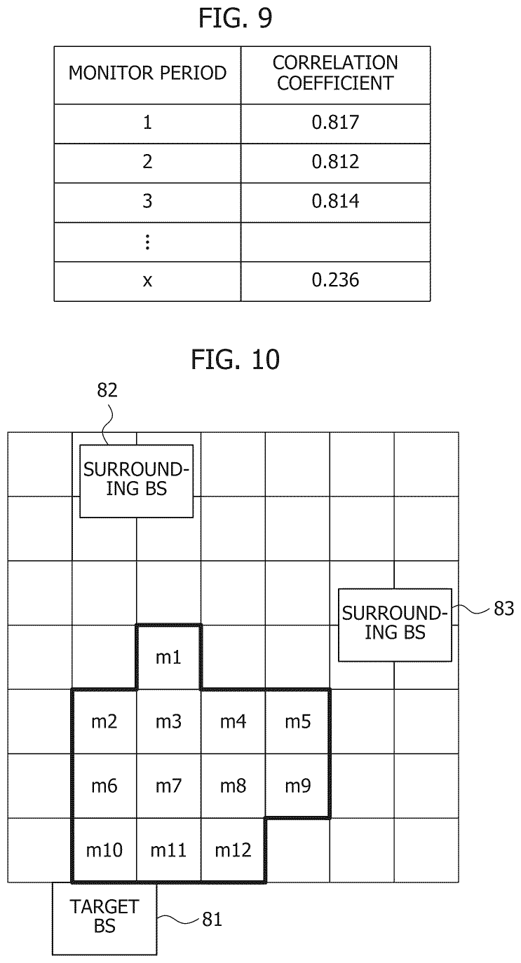

The cell/cell correlation calculation unit 61a calculates a correlation coefficient between the traffic volume of the target cell and the traffic volume of the reference cell on the basis of the distribution of the 24 sampling pair values for each monitor period. A method of calculating a correlation coefficient between an X component element and a Y component element on the basis of a distribution of a plurality of values plotted on the XY plane is realized by using a known technique. As illustrated in FIG. 9, the cell/cell correlation calculation unit 61a stores the correlation coefficient calculated for each monitor period in time series.

In the embodiment illustrated in FIGS. 5 to 9, the correlation coefficient for the traffic volume is calculated between the target cell and the reference cell, but a correlation coefficient related to another communication state may be calculated. For example, the cell/cell correlation calculation unit 61a may calculate a correlation coefficient for the traffic volume and a correlation coefficient for the number of pieces of the UE 2 between the target cell and the reference cell for each monitor period.

Next, an operation of the cell/area correlation calculation unit 61b will be described. The cell/area correlation calculation unit 61b calculates a correlation between a communication state of a target base station that provides a target cell and a communication state within a communication area of the target base station.

FIG. 10 is a diagram for describing traffic in a communication area of a base station. The cell/area correlation calculation unit 61b uses, for example, map data to divide a communication area covered by a communication company into a plurality of mesh blocks. A shape of the mesh block is not particularly limited, but is, for example, a square shape. In this case, the size of the mesh block is, for example, 100 meters×100 meters. In the following description, a base station that provides a target cell may be referred to as a “target base station”. Each base station providing each surrounding cell may be referred to as a “surrounding base station”.

The cell/area correlation calculation unit 61b specifies a communication area of a target base station 81. First, the cell/area correlation calculation unit 61b refers to the PM data and the position data of each piece of UE 2, and detects a mesh block in which the UE 2 connected to the target base station 81 is present. In the embodiment illustrated in FIG. 10, the target base station 81 has been connected from the UE 2 located in each of the mesh blocks m1 to m12. In this case, an area including mesh blocks m1 to m12 is regarded as a communication area of the target base station 81.

The cell/area correlation calculation unit 61b calculates a traffic volume of the target base station 81 with reference to the PM data. The cell/area correlation calculation unit 61b calculates a total traffic volume in the communication area of the target base station 81 with reference to the PM data and the position data of each UE 2. That is, the sum of the traffic volumes of the pieces of UE 2 located in the mesh blocks m1 to m12 is calculated. However, in many cases, a plurality of cells provided by the radio communication system partially overlap each other. Therefore, most of a large number of the pieces of UE 2 located in the mesh blocks m1 to m12 are connected to the target base station 81, but some UE 2 may be connected to other base stations (that is, surrounding base stations). Therefore, the cell/area correlation calculation unit 61b specifies pieces of UE 2 located in the mesh blocks m1 to m12, and refers to the PM data of the target cell and the PM data of the surrounding cells to calculate a sum of the traffic volumes of the specified pieces of UE 2. As a result, the total traffic volume in the communication area of the target base station 81 is calculated.

In the present embodiment, some of the plurality of pieces of UE 2 located in the mesh blocks m1 to m12 are connected to the surrounding base stations 82 and 83. In this case, a sum of the traffic volume of each piece of UE 2 connected to the target base station 81, the traffic volume of each piece of UE 2 located in the mesh blocks m1 to m12 and connected to the surrounding base station 82, and the traffic volume of each piece of UE 2 located in the mesh blocks m1 to m12 and connected to the surrounding base station 83 is calculated.

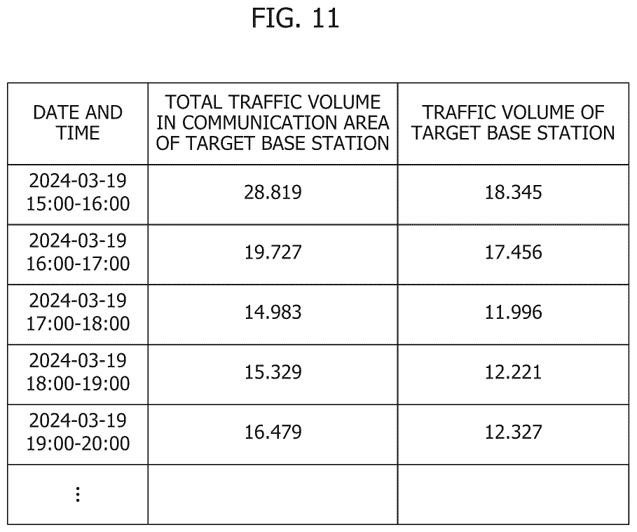

FIG. 11 illustrates an example of a traffic volume calculated for a target base station. In this example, the traffic volume of the target base station 81 and the total traffic volume in the communication area of the target base station 81 are calculated every hour.

Here, the traffic of the target base station 81 is a part of the total traffic in the communication area of the target base station 81. Therefore, it is considered that when the total traffic volume in the communication area of the target base station 81 increases, the traffic volume of the target base station 81 also increases, and when the total traffic volume in the communication area of the target base station 81 decreases, the traffic volume of the target base station 81 also decreases. That is, when the target base station 81 is operating normally, a correlation coefficient between the traffic volume of the target base station 81 and the total traffic volume in the communication area of the target base station 81 is expected to be high.

Therefore, the cell/area correlation calculation unit 61b monitors a correlation coefficient representing the similarity between the traffic volume of the target base station 81 and the total traffic volume in the communication area of the target base station 81. The correlation coefficient is calculated, for example, by using the method described with reference to FIGS. 7 to 8B. In this case, the cell/area correlation calculation unit 61b calculates a correlation coefficient for each monitor period. The cell/area correlation calculation unit 61b stores the correlation coefficient calculated for each monitor period in time series.

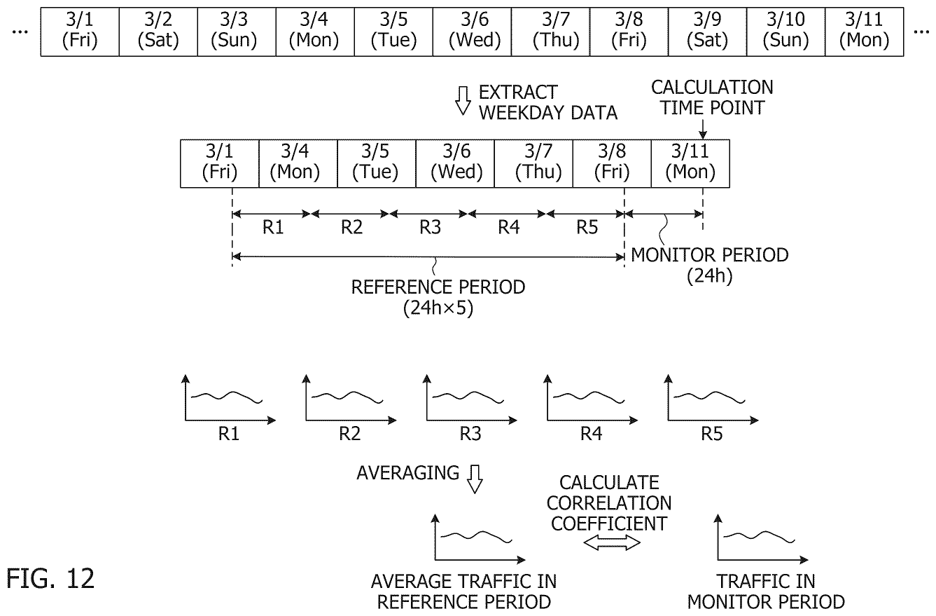

FIG. 12 illustrates an example of an operation of the autocorrelation calculation unit 61c. The autocorrelation calculation unit 61c calculates an autocorrelation coefficient of traffic data for each cell in order to monitor whether a behavior of traffic having a predetermined tendency follows the tendency. The present embodiment focuses on the fact that weekday traffic and holiday traffic each have unique tendencies. The holiday includes Saturday, Sunday, and a national holiday. In the following description, an autocorrelation coefficient of traffic on weekdays is calculated.

In the present embodiment, traffic data of a target cell in a period from March 1 to March 11 is stored. The autocorrelation calculation unit 61c extracts traffic data of a target cell on weekdays (here, March 1, March 4 to March 8, and March 11). A monitor period is set for the extracted traffic data (hereinafter, weekday traffic data). The monitor period is 24 hours as in the embodiment illustrated in FIG. 7. The weekday traffic data is an example of specific communication state data that satisfies a predetermined condition and is extracted from the traffic data of the target cell.

The autocorrelation calculation unit 61c sets a reference period for the monitor period. The reference period is set immediately before the monitor period in the weekday traffic data. Since there are five weekdays in one week, the length of the reference period is 5×24 hours. In this case, the reference period includes five sub-reference periods R1 to R5. The length of each of the sub-reference periods R1 to R5 is 24 hours. The autocorrelation calculation unit 61c creates average traffic data in the reference period by averaging the traffic data in each of sub-reference periods R1 to R5.

The autocorrelation calculation unit 61c calculates a correlation coefficient between the traffic data in the monitor period and the average traffic data in the reference period. That is, the autocorrelation coefficient is obtained for the traffic data of the target cell. Similarly, the autocorrelation calculation unit 61c calculates the autocorrelation coefficient for each monitor period while shifting the monitor period by one hour. The autocorrelation calculation unit 61c stores the autocorrelation coefficient calculated for each monitor period in time series.

When the target base station is operating normally, it is considered that the traffic data in the monitor period is similar to the average traffic data in the reference period. That is, when the target base station is normal, the autocorrelation coefficient between the traffic data in the monitor period and the average traffic data in the reference period is considered to be high. In other words, when a failure occurs in the target base station, it is considered that the autocorrelation coefficient between the traffic data in the monitor period and the average traffic data in the reference period decreases.

In the above-described embodiment, the autocorrelation coefficient for the traffic data on weekdays is calculated, but the autocorrelation coefficient for the traffic data on holidays may be calculated. In this case, the length of the reference period is 2×24 hours.

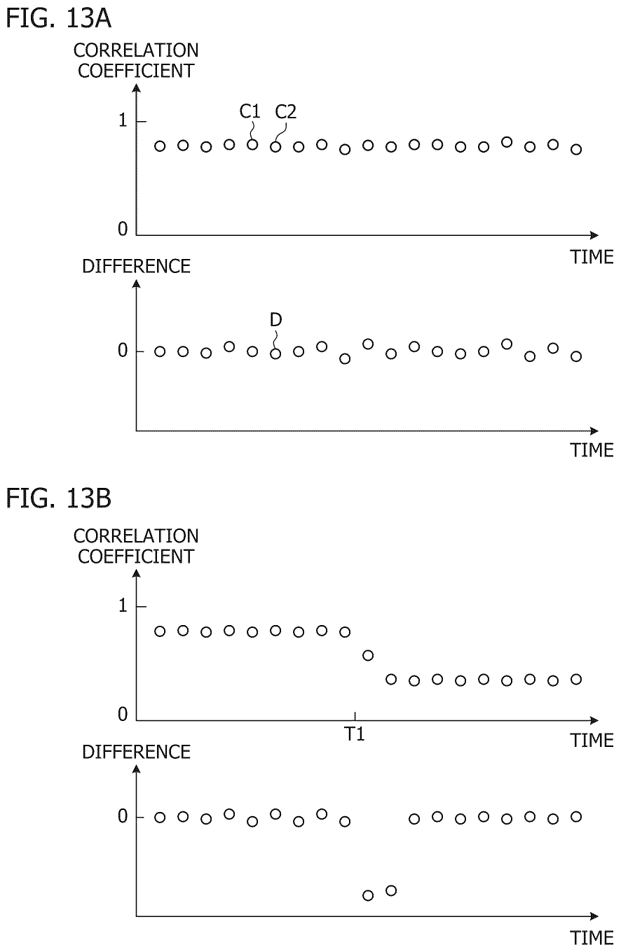

FIGS. 13A to 15 illustrate examples of a process of generating feature amount data from correlation coefficient data. The conversion unit 62 generates feature amount data from the correlation coefficient data calculated by the correlation calculation unit 61. The correlation coefficient data includes correlation coefficient data calculated by the cell/cell correlation calculation unit 61a, correlation coefficient data calculated by the cell/area correlation calculation unit 61b, and autocorrelation coefficient data calculated by the autocorrelation calculation unit 61c. However, in the description related to FIGS. 13A to 15, the “correlation coefficient data” represents correlation coefficient data related to the traffic volume calculated by the cell/cell correlation calculation unit 61a or the cell/area correlation calculation unit 61b.

In the case illustrated in FIG. 13A, the target base station that provides the target cell is operating normally. It is assumed that a surrounding base station (here, a base station that provides a reference cell) located in the vicinity of the target base station is also operating normally. In this case, a correlation coefficient related to the traffic volume of the target cell is stable at a relatively high value. In the graph representing the correlation coefficient illustrated in FIG. 13A, one “∘” mark represents a correlation coefficient calculated in one monitor period. The same applies to FIGS. 13B, 14, and 15. The conversion unit 62 generates difference data for each monitor period. The difference data represents a difference between the correlation coefficient obtained in the target monitor period and the correlation coefficient obtained in the monitor period immediately before the target monitor period. For example, as illustrated in FIG. 7, when the monitor period is shifted by one hour and set, the difference is calculated in units of one hour. In the embodiment illustrated in FIG. 13A, a difference D represents a difference between a correlation coefficient C1 and a correlation coefficient C2. However, the conversion unit 62 may calculate a difference between a correlation coefficient obtained in the target monitor period and a correlation coefficient obtained in a monitor period at a time separated from the target monitor period by a predetermined time (for example, a monitor period two hours before the target monitor period).

When the target base station is operating normally, the correlation coefficient related to the traffic volume of the target cell is stable, so that the difference calculated for each monitor period is stable at a value close to zero. In other words, when the difference data is stable in a state of being close to zero, it is estimated that the target base station is operating normally.

In the case illustrated in FIG. 13B, a failure occurs in the target base station at time point T1, and thereafter, the processing capability of the target base station decreases. In this case, it is assumed that a surrounding base station (here, a base station that provides a reference cell) is operating normally. In this case, the correlation coefficient related to the traffic volume of the target cell decreases. Due to the occurrence of the failure, an absolute value of the difference calculated by the conversion unit 62 increases. Therefore, when the absolute value of the difference calculated by the conversion unit 62 increases, it is estimated that there is a possibility that a failure has occurred in the target base station.

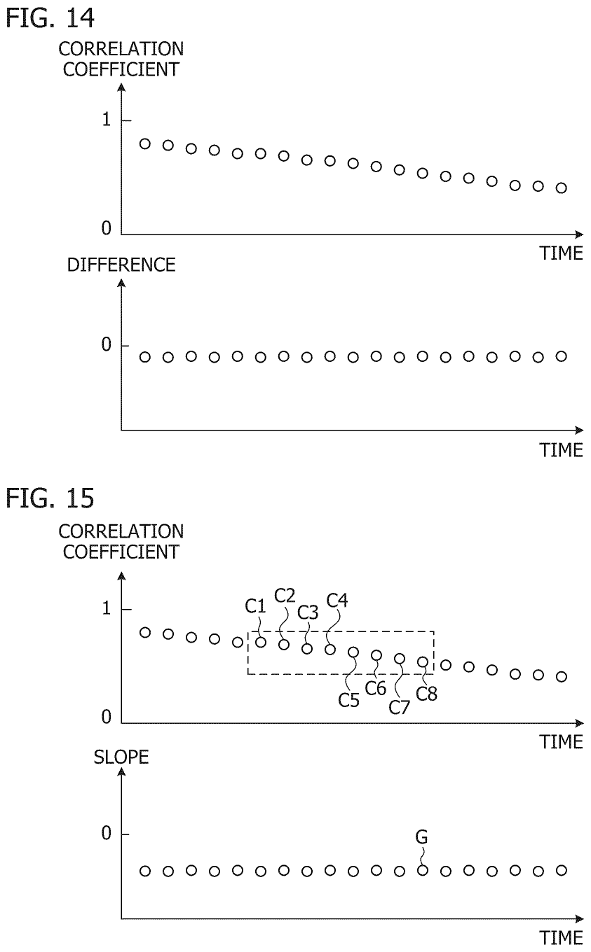

In the case illustrated in FIG. 14, the performance of the target base station gradually degrades. In this case, it is assumed that a surrounding base station (here, a base station that provides a reference cell) is operating normally. In this case, the correlation coefficient related to the traffic volume of the target cell gradually decreases. However, in a case where the correlation coefficient changes slowly, an absolute value of the difference calculated by the conversion unit 62 is small. Therefore, in this case, it is difficult to estimate whether a failure has occurred in the target base station on the basis of the difference data.

Therefore, the conversion unit 62 generates slope data in addition to the difference data. The slope data represents a tendency (that is, the slope with respect to time) of a change in a plurality of correlation coefficients obtained within a predetermined period. In the example illustrated in FIG. 15, a slope G is calculated on the basis of eight consecutive correlation coefficients C1 to C8. As illustrated in FIG. 7, when the monitor period is shifted by one hour and set, for example, the slope may be calculated on the basis of 24 correlation coefficients obtained in the immediately preceding 24 hours.

When the performance of the target base station gradually degrades, as illustrated in FIG. 15, a state in which the slope data is shifted from zero in the negative direction continues for a long period. Therefore, when the state in which the slope data is shifted from zero in the negative direction continues for a long period, it is estimated that the performance of the target base station gradually degrades.

Next, an operation of the failure prediction unit 70 will be described. The failure prediction unit 70 determines a state of the target base station or the target cell on the basis of the feature amount data (difference data and slope data) generated by the conversion unit 62. Alternatively, the failure prediction unit 70 may determine the state of the target base station or the target cell on the basis of the correlation coefficient data calculated by the correlation calculation unit 61 and the feature amount data generated by the conversion unit 62. That is, the failure prediction unit 70 predicts a failure in the base station that provides the target cell.

Here, as described with reference to FIGS. 13A to 15, the failure prediction unit 70 may predict the failure in the base station on the basis of the difference data and the slope data of the correlation coefficient. For example, when a difference larger than a predetermined threshold is detected, the failure prediction unit 70 may estimate that a failure has occurred in the target base station. Alternatively, when the state in which the slope data is shifted from zero continues for a long period, the failure prediction unit 70 may estimate that the performance of the target base station gradually degrades. The failure prediction unit 70 may predict the state of the base station by using an AI model.

The AI model is not particularly limited, but is realized by, for example, a gradient boosting decision tree (GBDT). In the GBDT, a decision tree that is one of machine learning algorithms is used. Boosting, which is one of ensemble learning, is used. During boosting, a gradient descent method is used to minimize an error of the previous prediction value.

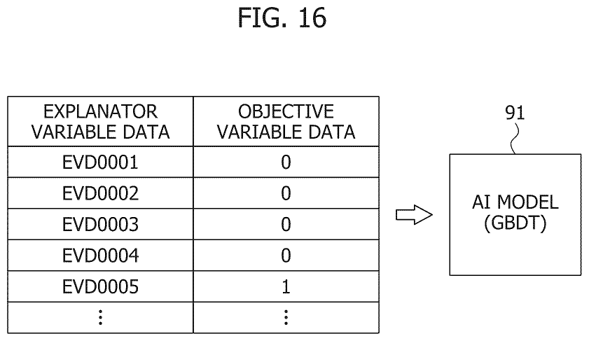

FIG. 16 illustrates an example of learning of an AI model. At the time of learning of an AI model 91, for example, teacher information acquired from a communication company is used. The teacher information includes a pair of an explanatory variable and an objective variable. The objective variable represents a variable desired to be predicted in machine learning. The explanatory variable represents a variable that can explain the objective variable.

When the AI model 91 operates as the failure prediction unit 70, the objective variable in the teacher information indicates whether a base station is normal. In the present embodiment, “0” represents a state in which a base station is normal, and “1” represents a state in which a failure occurs in the base station. The explanatory variable is not particularly limited, but includes, for example, the following information for each cell.
(1) Traffic volume of base station
(2) Number of pieces of UE connected to base station
(3) Feature amount (difference and slope) related to similarity to reference cell
(4) Feature amount (difference and slope) related to similarity to total traffic volume in communication area
(5) Deviation from average traffic pattern on weekdays/holidays

The information (1) and the information (2) are obtained from the PM data. The information (3) is generated on the basis of the correlation coefficient obtained by the cell/cell correlation calculation unit 61a. The information (4) is generated on the basis of the correlation coefficient obtained by the cell/area correlation calculation unit 61b. The information (5) is generated on the basis of the autocorrelation coefficient obtained by the autocorrelation calculation unit 61c.

The AI model 91 includes a plurality of parameters for calculating the objective variable from the explanatory variable. The plurality of parameters are updated such that the objective variable (that is, an answer) is obtained from the explanatory variable in the teacher information. For example, in the case illustrated in FIG. 16, the AI model 91 is updated such that the output value approaches “0” when the explanatory variable data EVD0001 is given, and is updated such that the output value approaches “1” when the explanatory variable data EVD0005 is given.

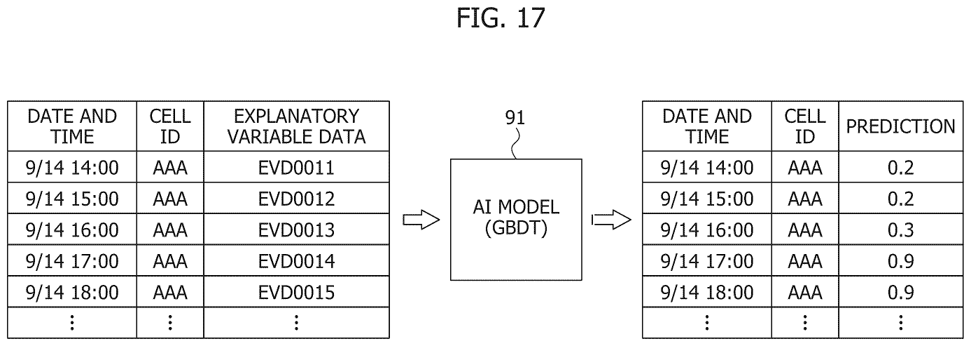

FIG. 17 illustrates an example of a method of predicting a failure in a base station by using a trained AI model. It is assumed that the AI model 91 has been trained by using the method illustrated in FIG. 16.

The failure prediction unit 70 predicts the state of the base station providing each cell using the updated AI model 91. Specifically, for each cell, the failure prediction unit 70 gives the above-described information (1) to (5) to the AI model 91 for each predetermined time period. A prediction value is output from the AI model 91. Here, the AI model 91 is trained such that the prediction value approaches “1” as the likelihood that a failure has occurred becomes higher, and the prediction value approaches “0” as the likelihood that a failure has occurred becomes lower. Therefore, the failure prediction unit 70 determines that a failure has occurred when the predicted value exceeds a predetermined threshold (For example, 0.5).

The AI model illustrated in FIGS. 16 and 17 needs to use teacher information acquired from a communication company. Therefore, when the teacher information is not allowed to be obtained from the communication company, the failure prediction unit 70 predicts a failure in the base station by using another method.

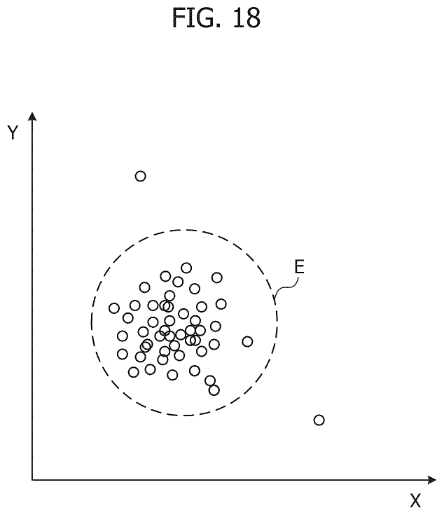

FIG. 18 illustrates an example of another method of predicting a failure in a base station. In the present embodiment, the failure prediction unit 70 predicts a failure in the base station by using principal component analysis. In the principal component analysis, some principal components are created by aggregating data having a large number of variables. This method corresponds to unsupervised learning that eliminates the need for teacher information.

In the present embodiment, two principal components (an X component and a Y component) are created from the information (1) to (5) described with reference to FIGS. 16 and 17. The principal component analysis in which main elements are created from a large number of elements (that is, a dimension is reduced) is realized by using a known technique.

The failure prediction unit 70 plots the principal component data (the X component and the Y component) obtained through the principal component analysis on the two-dimensional coordinates for each time period. In FIG. 18, one mark “∘” indicates principal component data calculated for one cell.

Here, values of principal component data of normal cells are considered to be close to each other. That is, it is considered that the principal component data of the normal cells appears around specific coordinates when plotted on two-dimensional coordinates. Therefore, the probability of occurrence of abnormality can be estimated according to a distance from the center of the distribution of the plotted principal component data.

For example, a cell plotted inside a region E illustrated in FIG. 18 is estimated to be a normal cell. On the other hand, it is estimated that there is a possibility that an abnormality has occurred in two cells plotted outside the region E.

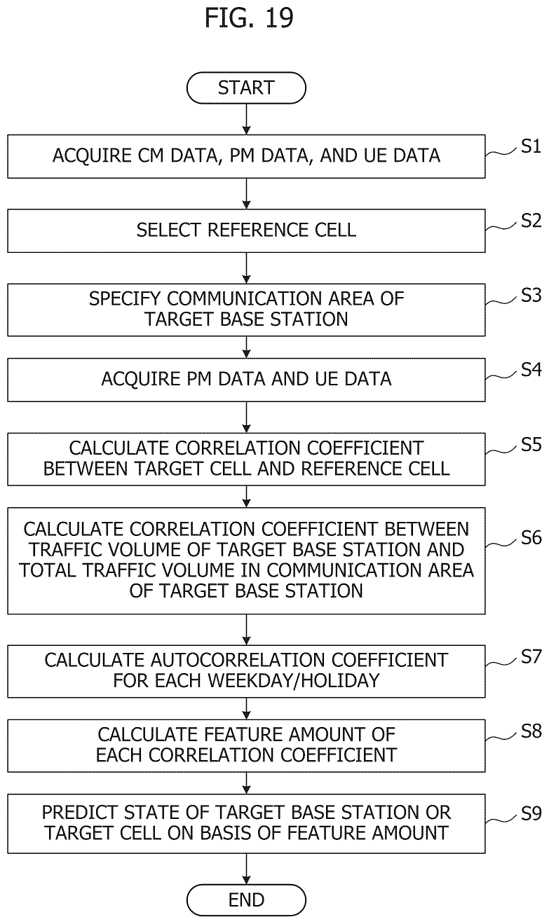

FIG. 19 is a flowchart illustrating an example of a process of the failure prediction apparatus 40. The process in this flowchart is executed by the non-real-time RIC 10 in the radio communication system 1 illustrated in FIG. 1. This process is executed on each base station (or each cell) provided by a communication company. In the following description, a cell in which the procedure illustrated in FIG. 19 is executed will be referred to as a “target cell”, and a base station that provides the target cell will be referred to as a “target base station”.

In S1, the data collection unit 50 collects CM data, PM data, and UE data from the base station system. In S2, the feature amount calculation unit 60 selects a reference cell for the target cell on the basis of the CM data and the PM data. In S3, the feature amount calculation unit 60 specifies a communication area of the target base station on the basis of the CM data, the PM data, and the UE data. Thereafter, the failure prediction apparatus 40 periodically and repeatedly executes the processes in S4 to S9.

In S4, the data collection unit 50 acquires PM data and UE data from the base station. In S5, the feature amount calculation unit 60 calculates a correlation coefficient between a communication state of the target cell and a communication state of the reference cell. The communication state data for which the correlation coefficient is calculated represents a traffic volume and/or the number of pieces of UE. In S6, the feature amount calculation unit 60 calculates a correlation coefficient between the traffic volume of the target base station and the total traffic volume in the communication area specified in S3. In S7, the feature amount calculation unit 60 calculates an autocorrelation coefficient of the traffic volume of the target cell for each weekday/holiday.

In S8, the feature amount calculation unit 60 calculates feature amounts for the correlation coefficients calculated in S5 to S7. The feature amount corresponds to the difference data described with reference to FIGS. 13A and 13B and the slope data described with reference to FIG. 15. In S9, the failure prediction unit 70 predicts a state of the target base station or the target cell on the basis of the feature amount calculated by the feature amount calculation unit 60 in S8. As a result, when there is a possibility that the target base station has failed, the failure prediction apparatus 40 may output an alarm.

As described above, the failure prediction apparatus 40 according to the embodiment of the present invention predicts a failure in each base station. Here, it is difficult to identify a state in which the requested traffic volume decreases and a state in which the performance of the base station degrades due to a failure or the like only by individually monitoring a communication state of each base station. On the other hand, the failure prediction apparatus 40 according to the embodiment of the present invention predicts a failure in the target base station on the basis of the similarity between the communication state of the target base station and the communication state of the surrounding base station and/or the change in the similarity between the communication state of the target base station and the communication state in the communication area of the target base station. Therefore, according to the embodiment of the present invention, it is possible to identify a state in which the requested traffic volume decreases and a state in which the performance of the base station degrades due to a failure or the like, and thus, the accuracy of failure prediction increases.

The failure prediction apparatus 40 determines a state of the target base station or a state of the target cell. For example, when the target base station is normal but the radio wave environment in the target cell deteriorates, the failure prediction apparatus 40 can detect that a failure has occurred in the target cell.

In the above embodiment, the correlation coefficient between the communication state of the target cell and the communication state of one reference cell is calculated, but the embodiment of the present invention is not limited to this configuration. For example, the failure prediction apparatus 40 may calculate a correlation coefficient between a communication state of the target cell and communication states of a plurality of surrounding cells. In this case, for example, the communication state of the target base station or the target cell is determined on the basis of the similarity between the communication state of the target cell and the average of the communication states of the plurality of surrounding cells.

### <Hardware Configuration>

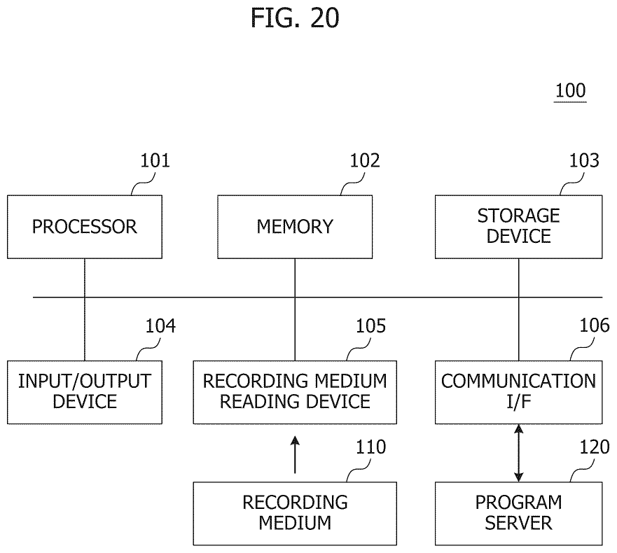

FIG. 20 illustrates an example of a hardware configuration of the failure prediction apparatus 40. The failure prediction apparatus 40 is implemented by a computer system 100 including a processor system 101, a memory 102, a storage device 103, an input/output device 104, a recording medium reading device 105, and a communication interface 106.

The processor system 101 can execute a failure prediction program and other programs stored in the storage device 103. The failure prediction program is executed as rApp in the non-real-time RIC 10 illustrated in FIG. 1, for example. The processor system 101 is implemented by one or a plurality of processors. When the processor system 101 includes a plurality of processors, the plurality of processors may be connected to each other via a network. The processor system 101 executes the failure prediction program to provide the functions of the data collection unit 50, the feature amount calculation unit 60, and the failure prediction unit 70 illustrated in FIG. 2. The memory 102 is used as a work area of the processor system 101. The storage device 103 stores the above-described failure prediction program and other programs. The database 12 illustrated in FIG. 1 is implemented by the memory 102 and/or the storage device 103.

The input/output device 104 may include an input device such as a keyboard, a mouse, a touch panel, or a microphone. The input/output device 104 may include an output device such as a display device or a speaker. The recording medium reading device 105 may acquire data and information recorded in the recording medium 110. The recording medium 110 is a removable recording medium detachable from the computer system 100. The recording medium 110 is implemented by, for example, a semiconductor memory, a medium that records a signal through an optical action, or a medium that records a signal through a magnetic action. The failure prediction program may be provided from the recording medium 110 to the computer system 100. The communication interface 106 provides a function of connecting to a network. When the failure prediction program is stored in a program server 120, the computer system 100 may acquire the failure prediction program from the program server 120.

According to the above aspect, the accuracy of predicting a failure in a radio communication system is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a failure prediction program for causing a computer to execute a process comprising:
generating at least one of first correlation coefficient data representing a similarity between first communication state data representing a communication state of a first cell provided by a first base station and second communication state data representing a communication state of a second cell provided by a second base station, or second correlation coefficient data representing a similarity between the first communication state data and third communication state data representing a communication state in a communication area of the first base station; and
determining a state of the first base station or the first cell on the basis of at least one of the first correlation coefficient data or the second correlation coefficient data.

2. The non-transitory computer-readable storage medium storing therein the failure prediction program according to claim 1,
wherein
the first correlation coefficient data is generated by calculating a first correlation coefficient representing the similarity between the first communication state data and the second communication state data for each predetermined monitor period, and
the second correlation coefficient data is generated by calculating a second correlation coefficient representing the similarity between the first communication state data and the third communication state data for each predetermined monitor period.

3. The non-transitory computer-readable storage medium storing therein the failure prediction program according to claim 2,
the failure prediction program further causing a computer to execute a process comprising
when the first correlation coefficient data is generated, generating first difference data representing a difference between the first correlation coefficients calculated for two different monitor periods, and first slope data representing a slope of the first correlation coefficient with respect to time; and
determining a state of the first base station or the first cell on the basis of the first difference data and the first slope data.

4. The non-transitory computer-readable storage medium storing therein the failure prediction program according to claim 2,
wherein
the first communication state data represents a traffic volume of the first cell,
the second communication state data represents a traffic volume of the second cell, and
the first correlation coefficient represents a similarity between the traffic volume of the first cell and the traffic volume of the second cell calculated for each monitor period.

5. The non-transitory computer-readable storage medium storing therein the failure prediction program according to claim 2,
wherein
the first communication state data represents the number of terminals connected to the first base station,
the second communication state data represents the number of terminals connected to the second base station, and
the first correlation coefficient represents a similarity between the number of terminals connected to the first base station and the number of terminals connected to the second base station, the number of the terminals being calculated for each monitor period.

6. The non-transitory computer-readable storage medium storing therein the failure prediction program according to claim 2,
the failure prediction program further causing a computer to execute a process comprising:
when the second correlation coefficient data is generated, generating second difference data representing a difference between the second correlation coefficients calculated for two different monitor periods, and second slope data representing a slope of the second correlation coefficient with respect to time; and
determining a state of the first base station or the first cell on the basis of the second difference data and the second slope data.

7. The non-transitory computer-readable storage medium storing therein the failure prediction program according to claim 2,
wherein
the first communication state data represents a traffic volume of the first base station,
the third communication state data represents a total traffic volume in the communication area of the first base station, and
the second correlation coefficient represents a similarity between the traffic volume of the first base station and the total traffic volume in the communication area of the first base station, the traffic volume and the total traffic volume being calculated for each monitor period.

8. The non-transitory computer-readable storage medium storing therein the failure prediction program according to claim 1,
the failure prediction program further causing a computer to execute a process comprising:
extracting specific communication state data satisfying a predetermined condition from the first communication state data;
generating autocorrelation coefficient data by calculating an autocorrelation coefficient of the specific communication state data for each predetermined monitor period; and
determining a state of the first base station or the first cell on the basis of the autocorrelation coefficient data.

9. The non-transitory computer-readable storage medium storing therein the failure prediction program according to claim 1,
the failure prediction program further causing a computer to execute a process comprising:
selecting, as the second cell, a surrounding cell having a communication state with a highest similarity to the communication state of the first cell from among a plurality of surrounding cells provided in the vicinity of the first cell.

10. A failure prediction apparatus comprising:
a correlation calculator that generates at least one of first correlation coefficient data representing a similarity between first communication state data representing a communication state of a first cell provided by a first base station and second communication state data representing a communication state of a second cell provided by a second base station, or second correlation coefficient data representing a similarity between the first communication state data and third communication state data representing a communication state in a communication area of the first base station; and
a predictor that determines a state of the first base station or the first cell on the basis of at least one of the first correlation coefficient data or the second correlation coefficient data.

11. A radio communication system comprising:
a base station system that provides a plurality of cells by using a plurality of base stations; and
a control system that controls the plurality of base stations, wherein
the control system includes a failure prediction apparatus that determines states of the plurality of base stations or the plurality of cells, and
the failure prediction apparatus includes
a correlation calculator that generates at least one of first correlation coefficient data representing a similarity between first communication state data representing a communication state of a first cell provided by a first base station and second communication state data representing a communication state of a second cell provided by a second base station, or second correlation coefficient data representing a similarity between the first communication state data and third communication state data representing a communication state in a communication area of the first base station, and
a predictor hat determines a state of the first base station or the first cell on the basis of at least one of the first correlation coefficient data or the second correlation coefficient data.
